(19) United States
(12) Patent Application Publication
(10) Pub. No.: US 2023/0114935 A1
(43) Pub. Date: Apr. 13, 2023

(54) METHOD FOR DETERMINING AND IMPLEMENTING A DATA COLLECTION PROGRAM FOR ONE OR MORE PHASES OF HYDROCARBON EXTRACTION BASED ON SEQUENTIAL SUBSURFACE UNCERTAINTY CHARACTERIZATION

(71) Applicant: ExxonMobil Upstream Research Company, Spring, TX (US)

(72) Inventors: Shuai HE, Spring, TX (US); Fahim FOROUZANFAR, Houston, TX (US)

(21) Appl. No.: 17/937,815

(22) Filed: Oct. 4, 2022

Related U.S. Application Data
(60) Provisional application No. 63/262,203, filed on Oct. 7, 2021.

(51) Int. Cl. G01V 99/00; E21B 43/00; E21B 47/00

(52) U.S. Cl. CPC G01V 99/005; E21B 43/00; E21B 47/00

(57) ABSTRACT

A method for determining and implementing a data collection program is disclosed. Data is typically collected in order to develop a subsurface model that can characterize a subsurface to assist in hydrocarbon management. However, it may be difficult to determine how much, or what type of data, to obtain so that the subsurface model is of sufficient certainty. In particular, parameters that define the model and outputs of the model (defined as quantities of interest (QoIs)) are subject to uncertainty. In order to reduce the uncertainty of the QoIs to an acceptable level, data collection programs are iteratively selected based on sequential subsurface uncertainty characterization. In this way, the data collection programs, when implemented, may collect a sufficient amount of data to reduce uncertainty of the subsurface model for subsequent use in hydrocarbon management.

### CROSS-REFERENCE TO RELATED APPLICATION

This application claims the benefit of U.S. Provisional Application 63/262,203, entitled “A Method for Determining and Implementing a Data Collection Program for One or More Phases of Hydrocarbon Extraction Based on Sequential Subsurface Uncertainty Characterization,” filed Oct. 7, 2021, the disclosure of which is hereby incorporated by reference in its entirety.

### FIELD OF THE INVENTION

The present application relates generally to the field of hydrocarbon exploration, development and production. Specifically, the disclosure relates to a methodology for determining and implementing an appraisal data collection program based on sequential subsurface uncertainty characterization.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In the oil and gas industry, business decisions are typically made based on an understanding of the subsurface, such as an understanding of one or more subsurface geological properties of the subsurface (e.g., permeability, porosity, water-oil-contact depth, water-gas-contact depth, flow barriers, flow conduits, phase behavior of subsurface oil and gas, and the like). However, knowledge about the subsurface geological properties of any particular area may be extremely limited. The subsurface properties can be partially determined by techniques such as seismic imaging, appraisal drilling, well testing, and the like. In this regard, these techniques may provide information to characterize the subsurface; however, the cost associated with these techniques may be high.

### SUMMARY OF THE INVENTION

In one or some embodiments, a computer-implemented method for selecting and implementing a plurality of data collection components in order to collect data regarding at least a part of a subsurface is disclosed. The method includes: accessing a plurality of potential data collection components, each of the potential data collection components having one or both of an associated well and an associated test or seismic survey parameter designs for collecting data, the data used to characterize one or more quantities of interest (QoIs) regarding the subsurface, the QoIs comprising one or more parameters that define a subsurface model or one or more outputs of the subsurface model; quantitatively analyzing each of the plurality of potential data collection components for an uncertainty reduction on the one or more QoIs; selecting, based on the quantitative analysis and from the plurality of potential data collection components, a set of data collection components for testing; and implementing the set of data collection components for testing in order to collect the data to characterize the at least a part of the subsurface.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is an example flow diagram of the overall workflow.

FIG. 2 is an example of a flow diagram of performing uncertainty quantification and selecting a data component to reduce uncertainty, which expands on part of the flow diagram in FIG. 1.

FIG. 3A is a schematic showing multiple iterations of selecting components to reduce a range of uncertainty for a QoI for a layout of appraisal wells, such as illustrated in FIG. 3D.

FIG. 3B is a schematic showing multiple iterations of selecting components to reduce a percentage of uncertainty for a QoI for a layout of appraisal wells, such as illustrated in FIG. 3D.

FIG. 3C is a schematic showing multiple iterations of selecting components to reduce a range of uncertainty for a QoI across multiple phases of hydrocarbon extraction, including during an appraisal phase and a development phase.

FIG. 3D illustrates an example layout of appraisal wells.

FIG. 4 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “seismic data” as used herein broadly means any data received and/or recorded as part of the seismic surveying and interpretation process, including displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or interpretation quantities, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying and interpretation process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended. “Seismic data” may also include data derived from traditional seismic (e.g., acoustic) data sets in conjunction with other geophysical data, including, for example, gravity plus seismic; gravity plus electromagnetic plus seismic data, etc. For example, joint-inversion utilizes multiple geophysical data types.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

The term “geological features” (interchangeably termed geo-features) as used herein broadly includes attributes associated with a subsurface, such as any one, any combination, or all of: subsurface geological structures (e.g., channels, volcanos, salt bodies, geological bodies, geological layers, etc.); boundaries between subsurface geological structures (e.g., a boundary between geological layers or formations, etc.); or structure details about a subsurface formation (e.g., subsurface horizons, subsurface faults, mineral deposits, bright spots, salt welds, distributions or proportions of geological features (e.g., lithotype proportions, facies relationships, distribution of petrophysical properties within a defined depositional facies), etc.). In this regard, geological features may include one or more subsurface features, such as subsurface fluid features, that may be hydrocarbon indicators (e.g., Direct Hydrocarbon Indicator (DHI)). Examples of geological features include, without limitation salt, fault, channel, environment of deposition (EoD), facies, carbonate, rock types (e.g., sand and shale), horizon, stratigraphy, or geological time, and are disclosed in US Patent Application Publication No. 2010/0186950 A1, incorporated by reference herein in its entirety.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) may be represented by picture elements (pixels). Such numerical representations may be shape-based or functional forms in addition to, or in lieu of, cell-based numerical representations.

The term “subsurface model” as used herein refer to a numerical, spatial representation of a specified region or properties in the subsurface.

The term “geologic model” as used herein refer to a subsurface model that is aligned with specified geological feature such as faults and specified horizons.

The term “reservoir model” as used herein refer to a geologic model where a plurality of locations have assigned properties including any one, any combination, or all of rock type, EoD, subtypes of EoD (sub-EoD), porosity, clay volume, permeability, fluid saturations, etc.

For the purpose of the present disclosure, subsurface model, geologic model, and reservoir model are used interchangeably unless denoted otherwise.

A model within this disclosed framework may comprise a general model which provides mapping from parameter space to the output space and which includes, but is not limited to, the set of quantities of interest (QoIs). Further, the model may include, but is not limited to, any combination of structural, reservoir, seismic, or analytical models, which are processed in series or in parallel, to map the input to the output space. As discussed in more detail below, QoIs may include one or more parameters for the model and/or one or more outputs of the model. As one example, the one or more parameters (that may comprise QoIs) may include any one, any combination, or all of geological parameters (e.g., parameters of the model indicative of one or more geological features discussed above), fluid characterization parameters (e.g., one or more parameters associated with the fluid(s) injected into the subsurface, such as viscosity or the like), analytical model parameters, or other parameters used by the model. As another example, outputs of the model may comprise amount of oil produced, amount of oil reserve, size of the reservoir, etc. As discussed in more detail below, the parameters of the model and the outputs of the model may be uncertain (with data collection reducing the uncertainty). Further, the model may be manifested in several ways, such as through equations, look-up tables, or the like. Regardless of the manifestation, the model includes the one or more parameters and generates one or more outputs, one or both of which may comprise the QoIs. As another example, the one or more outputs of the model (that may comprise QoIs) may include one or both of static or dynamic behaviors of the subsurface.

Stratigraphic model is a spatial representation of the sequences of sediment, formations and rocks (rock types) in the subsurface. Stratigraphic model may also describe the depositional time or age of formations.

Structural model or framework results from structural analysis of reservoir or geobody based on the interpretation of 2D or 3D seismic images. For examples, the reservoir framework comprises horizons, faults and surfaces inferred from seismic at a reservoir section.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, preparation of an asset development plan requires understanding and characterizing the subsurface uncertainties, which is extremely challenging particularly because knowledge about the subsurface geological properties for any particular area may be limited. Uncertainty may be associated with one or more aspects of the subsurface. In particular, uncertainty may be directed to one or more aspects of a reservoir in the subsurface, including any one, any combination, or all of: descriptive aspect(s) (e.g., what the reservoir contains); size of the reservoir; productivity of the reservoir; or information indicative of the amount needed to produce from the reservoir (e.g., is the reservoir connected (connectivity) or do additional wells drill need to be drilled for extraction). Other uncertainty parameters are contemplated.

In one or some embodiments, the one or more aspects may comprise one or more quantities of interest (QoIs). As discussed in further detail below, the one or more QoIs may be related to the subsurface model, such as one or both of parameter(s) of the model (e.g., any one, any combination, or all of geological parameters, fluid characterization parameters, analytical model parameters, or other parameters used by the model) and/or one or more outputs of the model (e.g., one or both of static or dynamic behaviors of the subsurface). As one example, an output of the model may be considered a static property of the subsurface (e.g., an initially in-place volume). As another example, an output of the model may be considered a dynamic property of the subsurface responsive to changing conditions in the subsurface (e.g., after production commences, the in-place volume changes, an indicator of subsurface performance). As discussed in detail below, QoIs may include both parameters of the model (which is not dependent on input(s) to the model) and outputs of the model (which are dependent on both the parameters of the model and input(s) to the model). More specifically, one or more parameters of the model and one or more outputs related to or dependent on the parameters may be selected as QoIs. By way of example, the water/oil contact (which may characterize the depth at which the oil and water meet and is thus an indicator of the thickness of the oil column) may comprise a parameter of the model and may also be selected as a QoI. Further, the in-place volume of oil or amount of oil produced (both of which are dependent on the water/oil contact and one or more inputs) may be indicators of subsurface performance and may be selected as QoIs.

To reduce uncertainty, various techniques, such as any one, any combination, or all of the following may be performed: seismic imaging; appraisal drilling; well testing; etc. In particular, with regard to appraisal drilling, it may be difficult to determine where to drill the appraisal wells and what tests to conduct in order to reduce the uncertainty. With regard to well testing, it may likewise be difficult to determine which well tests to conduct in order to reduce the uncertainty. Typically, in order to reduce uncertainty, the decisions as to where and what tests to perform are mainly determined by the engineering and experts' qualitative judgement, which is both time consuming and less systematic/principled.

Thus, in one or some embodiments, a method and system are disclosed to quantitatively select a plurality of data collection components or programs (from a set of potential data collection components or programs) in order to reduce subsurface uncertainty to a defined level, range, percentage, or the like. In order to select the plurality of data collection programs, the method and system interdependently assess or analyze the potential data collection programs for uncertainty reduction in one or more quantities of interest (QoIs) in order to select the plurality data collection programs. In one or some embodiments, the method and system interdependently assess the potential data collection programs sequentially and iteratively.

In particular, in one or some embodiments, the methodology comprises a sequential workflow comprising (or consisting of) data collection component, in which at each sequence, the data collection component is hypothesized and the value of collected data is tested based on at least one metric. As discussed in more detail below, a plurality of potential data collection components (interchangeably referred to as potential data collections) may be formulated and developed by experts and may be indicative of a comprehensive set of tests. Various types of data collection components are contemplated. As one example, data collection components may comprise a test (or a set of tests) on a specific well (or a specific set of wells). In such data collection component, the tests are well specific. Alternatively, or in addition, the data collection components may comprise a specific design of a survey seismic. Seismic surveys may be designed using one or more parameters, which may impact the seismic data obtained, the cost incurred, or the activities to perform the survey. Merely by way of example, two parameters comprise the spacing between receivers and the shooting wavelet frequency. Values for the parameters may be selected in order to reduce the uncertainty of one or more QoIs. Again, by way of example, different shooting wavelet frequencies may show different resolutions of geological features (e.g., higher frequency surveys generate data may resolve higher resolution geological features whereas lower frequency surveys generate data may resolve lower resolution geological features). In this regard, the selection of the different parameters of the seismic surveys (as manifested in different data components, interchangeably termed data collection components or data collection programs) may reduce uncertainty of QoIs in different ways. Further, in contrast, such data collection components directed to seismic surveys need not be well specific.

The plurality of data collection components are then analyzed (such as in an iterative manner). In a first iteration, the methodology may analyze some or all the potential data collection components that are available. In particular, the methodology may analyze a respective potential data collection component, with the methodology assuming collection of the data from the respective potential data component collection (e.g., running a test on a specific well and collect data from the test). Then, the methodology evaluates the collected data and determines if the respective potential data collection component is sufficiently informative. For example, the methodology determines whether the respective potential data collection component sufficiently reduces uncertainty for one or more QoIs.

Various methodologies may be used in order to determine reduction of uncertainty. Merely by way of example, Bayesian Evidential Learning (BEL) or Goal Oriented Inference (GOI) may be used as efficient approaches to determine the reduction of uncertainty. If the respective potential data collection component is informative, the methodology selects the respective potential data collection component in the program. Otherwise, the methodology discards the respective potential data collection component. The methodology may repeat the process across some or all of the potential data components available and select the most informative component. In subsequent iterations, the methodology may repeat the process with the some or all of the remaining potential data components (e.g., minus the data component selected in previous iteration(s)). For example, in a second iteration, the methodology may select the second most informative component subject to having the first most informative component already collected (e.g., the methodology assumes that the data from the first most informative component, selected in the first iteration, is obtained).

Thus, the methodology, through its interdependent qualitative analysis, may select a subset of the plurality of potential data collection components in order to characterize the subsurface. More specifically, through iterations of uncertainty quantification analysis, the subset of the plurality of potential data collection components are selected to comprise the final data collection program. In turn, the final data collection program may be implemented, such as by drilling the appraisal wells and/or performing the tests, in order to generate data to characterize the subsurface sufficient (e.g., within a predefined uncertainty quantification). In turn, the generated data may be used, such as in generate a subsurface model. The subsurface model may then be used in order to characterize the subsurface, and assist in hydrocarbon resource management. In this regard, a data-driven approach for uncertainty quantification may be applied in an efficient and trackable manner for asset extraction from a subsurface.

In this way, the methodology may quantitatively assist in selecting the data collection programs for various phases of hydrocarbon exploration, including in one or more phases of hydrocarbon explanation. In particular, in one or some embodiments, the methodology may be used solely in the appraisal phase. For example, the methodology may assist in selecting the data collection programs in the appraisal phase (e.g., an appraisal phase set of data collection components or programs) to collect most informative data critical to the subsurface uncertainty quantification (and in turn generate a subsurface model with desired uncertainty). In this regard, the data collection programs in the appraisal phase may answer one or both of the following questions: (1) where to drill the appraisal wells and what data to be collected; and (2) when to stop drilling the additional appraisal wells. Alternatively, the methodology may be used in the appraisal phase and in one or more other hydrocarbon exploration phases, such as in the development phase and/or the production phase. Again, the methodology may assist in selecting the data collection programs in the development phase (e.g., a development phase set of data collection components or programs) and/or the production phase (e.g., a production phase set of data collection components or programs) to collect most informative data critical to the subsurface uncertainty quantification (and in turn generate a subsurface model with desired uncertainty for the respective phases). Further, in one or some embodiments, the methodology may reduce uncertainty for at least one same QoI (or multiple same QoIs) in the different phases. Alternatively, the methodology may reduce uncertainty for different QoIs in the different phases.

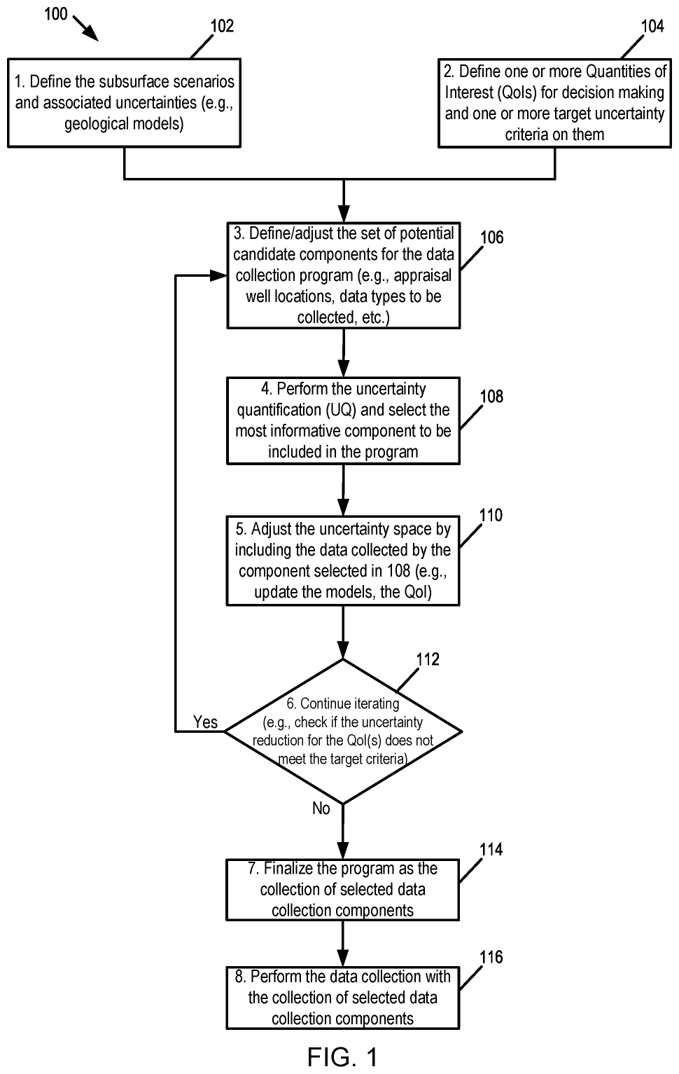

Referring to the figures, FIG. 1 is an example flow diagram 100 of the overall workflow. At 102, in step 1, the subsurface scenarios and the associated uncertainties are defined. As discussed above, the subsurface may be characterized in a variety of ways. Merely by way of example, the subsurface may be characterized by any one, any combination, or all of: geological structure; reservoir rock properties; fluid properties, or the like. Further, the characterization of the subsurface may be manifested in a variety of ways. Again, merely by way of example, the characterization of the subsurface may be manifested in different types of models (such as geological models, rock property models, etc.) and in different ways (e.g., numerical models).

At 104, in step 2, one or more Quantities of Interest (QoIs) for decision making and one or more target uncertainty criteria are defined. As discussed above, one or more QoIs may be subject to uncertainty reduction. Further, target uncertainty criteria (such as target uncertainty reduction in one or more phases, such as in an appraisal phase) may be assigned to one, some or each of the QoIs. In this way, the target uncertainty reduction may differ based on the respective QoI subject to analysis. Merely by way of example, two QoIs of interest may comprise QoI₁ and QoI₂, with QoI₁ have an associated target uncertainty reduction to 5% (e.g., the amount of data collected results in the range of values being reduced to 5% of the overall range of possible values for QoI₁) and with QoI₂ have an associated target uncertainty reduction to 3%. In this way, the selection of the data collection components may be such that the uncertainty reduction meets the designated targets.

QoI may comprise a key metric to quantify the decisions in selecting the one or more data components. As discussed above, business decisions may be based on an understanding of the subsurface. As such, the business decisions may be focused on various aspects of asset recovery. Merely by way of example, the QoI (or multiple QoI, hereinafter termed QoIs) may comprise any one, any combination, or all of: estimated ultimate recovery (EUR); production volume profile, size of the reservoir; fluid contacts; reservoir connectivity; or conditional/cumulative probabilities of any one, any combination, or all of the aforementioned quantities. In this regard, the QoIs may comprise one or more parameters for the subsurface models, discussed above, and/or may comprise one or more outputs generated by the subsurface models. In this way, the business decisions may be quantified to one or more QoIs so that the one or more data components, selected to meet the QoIs, may satisfy the business decisions.

Further, in the instance where uncertainty characterization is the focus, target uncertainty characterization criteria may be defined, such as by the expert judgment, and may be case dependent. Merely by way of example, the target uncertainty characterization may comprise one or more values, such as a range (e.g., 65-70%). In this way, the methodology may use the target uncertainty characterization when determining whether to continue or stop iterating (as discussed below).

By way of background, there are various phases in hydrocarbon extraction including exploration, testing (e.g., appraisal), development, and production. As discussed in more detail below, the methodology may be used in preparation for implementing an appraisal phase in which one or both of the following may be performed: determining the number/location of appraisal wells to drill; and the tests to perform at the appraisal wells.

The appraisal phase may occur following exploration when the existence of oil or gas has been proven, but the operator needs further information about the extent of the deposit or its production characteristics to establish whether it can be economically exploited. The appraisal phase may take several forms including additional seismic work, longer-term flow tests, the drilling of further wells, additional drilling at another site away from the exploration site or additional wells at the original exploration site, or hydraulic fracturing followed by flow testing to establish the economic viability of the resource and its potential productive life.

Thus, in one or some embodiments, the data collection components may include the various test or operations in one or more phases, such as in the appraisal phase, in order to reduce the uncertainty quantification. In this regard, at 106, in step 3, the methodology defines/adjusts the set of potential candidate components for the data collection program (e.g., appraisal well locations, data types to be collected, seismic designs, etc.).

Data collection components may be defined in a variety of ways. In one way, data collection components may be defined based on one or both of: a location (such as a well location); and/or a test (such as a type of test performed at the location). Further, in tests that have an adjustable duration, the data collection components may be defined based on three criteria: location; test; and duration. Example tests include, but are not limited to: pressure/rate transient test; fluid test; logs (e.g., porosity logs; resistivity logs; lithology logs; gamma log); coring (e.g., routine core analysis; special core analysis); production logging test; or modular pressure test (MPT). Further, the available tests may depend on the development phase. For example, a production logging test may be more applicable to more mature well (rather than an appraisal well). In contrast, a pressure/rate transient test is typically performed for an appraisal well. In this regard, the scope of tests may be dependent on the respective phase since certain tests may have more value in reducing uncertainty depending on the phase. In another way, data collection components may comprise seismic designs defined based on various parameters.

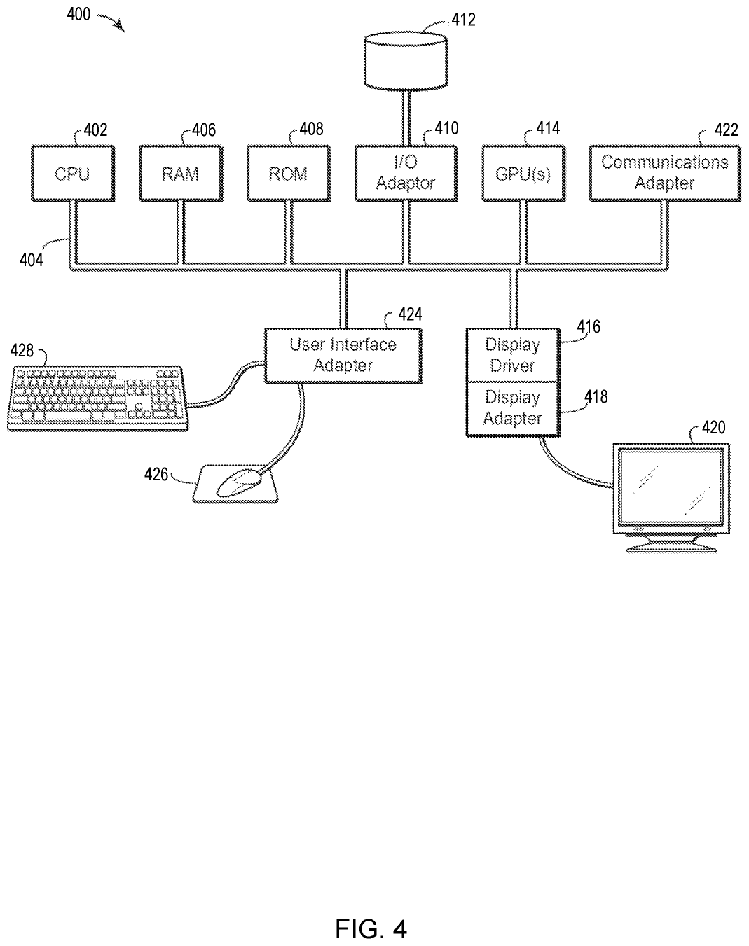

At 108, in step 4, the methodology performs the uncertainty quantification (UQ) and selects the most informative data collection component to be included in the program. FIG. 4 (discussed below) elaborates on step 4. Selection of the most informative data component may be performed in one of several ways. In one embodiment, the selection is based on uncertainty reduction, such as based on a highest absolute percentage of uncertainty reduction for the one or more QoIs or based on a comparison of the percentage uncertainty reduction relative to the respective target uncertainty reduction.

Alternatively, the selection may be based on iteratively focusing on different ones (or groups) of QoIs. For example, in a first pass, a highest priority QoI (or set of highest priority QoIs) may be the focus of uncertainty reduction. In this regard, the selection of data components may be based on the greatest uncertainty reduction for the highest priority QoI (or the set of highest priority QoIs). The methodology may iterate, selecting data components, until the uncertainty reduction for the highest priority QoI (or the set of highest priority QoIs) reaches the respective target uncertainty reduction for the highest priority QoI (or the target uncertainty reductions for the set of highest priority QoIs). After which, the methodology, in a second pass, may select a second highest priority QoI (or set of second highest priority QoIs) in order to select the data components for the reduction in uncertainty to the respective target uncertainty reduction for the second highest priority QoI (or target uncertainty reductions for the set of second highest priority QoIs). After which, the methodology may continue with subsequent passes until all of the QoIs of interest are examined. As such, in one or some embodiments, the iterations may end when the uncertainty percentage value for all of the QoIs meet respective target uncertainty percentage values or when all of the QoIs change less than a predetermined amount from a previous iteration to a current iteration.

Still alternatively, the methodology may weight the uncertainty reduction for the different QoIs in order to select the data components. For example, the methodology may iterate through selections of data components to reduce the weighted uncertainty reduction until each of the different QoIs meet the respective target uncertainty reductions. After a respective QoI has meet its target uncertainty reduction while other QoIs have not, the methodology may reduce (or eliminate) the respective QoI from the weighted uncertainty reduction while the other QoIs, which have not yet met their respective uncertainty reductions, may still be weighted.

At 110, in step 5, the methodology adjusts the uncertainty space by including the data collected by the component selected in 108 (e.g., update the models, with the uncertainty of the one or more QoIs being reduced based on the data collected). As discussed above, when a data collection component is selected (such as tentatively selected), the methodology then may assume that: (i) the selected data collection component has hypothetically been performed; and (ii) the data generated by the hypothetical performance of the selected data component reduces uncertainty (e.g., the models may be updated to reflect the reduction in uncertainty for QoI in one or more parameters within the model).

At 112, in step 6, the methodology determines whether to continue iterating (e.g., check if uncertainty reduction for the one or more QoIs does not meet the target criteria). As discussed above, the one or more QoIs are defined in step 2. In one or some embodiments, the methodology may determine whether the percentage uncertainty is within the acceptable range defined in step 2. If not, flow diagram 100 loops back to 106. Alternatively, or in addition, the methodology may determine whether the percentage uncertainty for each of the QoIs has not changed between iterations (indicating that further iterations will not reduce the percentage uncertainty further). In one or some embodiments, responsive to the methodology determining that the percentage uncertainty has not changed between iterations, flow diagram 100 moves to 114. Alternatively, responsive to the methodology determining that the percentage uncertainty has not changed between iterations, the methodology may loop back to 106 in order to define additional candidate components for data collection program.

At 114, in step 7, the methodology finalizes the program as the collection of selected data collection components. At 116, in step 8, the data collection is performed with the collection of selected data collection components. As one example, the appraisal wells may be drilled in the locations designated in the selected data collection components and/or the tests performed (with the associated designated durations) in order to obtain the data. Alternatively, or in addition, the selected seismic design(s) may be performed.

Flow diagram 100 includes a listing of seven steps as an example sequence; however, other sequences are contemplated. Merely by way of example, step 1 (102) may be performed prior to step 2 (104); alternatively, step 2 (104) may be performed prior to step 1 (102).

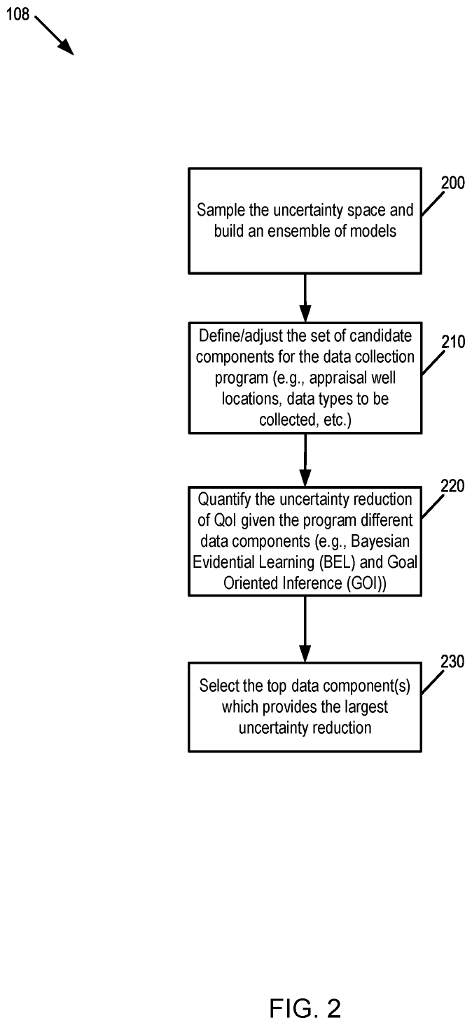

FIG. 2 is an example of a flow diagram expanding on 108 in which the methodology performs uncertainty quantification and selects a data component to reduce uncertainty, which expands on part of the overall flow diagram 100 in FIG. 1. As explained above, an important step in flow diagram 100 is step 4 (108) of performing the uncertainty quantification analysis and selecting the most informative component.

At 200, the methodology samples the uncertainty space and builds an ensemble of models. In particular, with the definition of subsurface scenarios and associated uncertainties (see step 1), the methodology may use any contemplated sampling technique (e.g., Latin Hypercube Search, Full Factorial Design) to obtain samples from the uncertainty space. The ensemble of models may be denoted as M={m₁, m₂, . . . , mₙ}, where n stands for the ensemble size. These models may be used to obtain the hypothesized data corresponding to different components formulated in step 2.

Further, 200 may be considered similar to the functions performed in 102 defining subsurface scenarios and associated uncertainties. However, 200 is indicative that the system is evolving by adding the data collection component (and the associated data) in order to further define the system and reduce uncertainty. In particular, at 102, the original space is defined without previously having selected any data collection components, whereas at 200, the added collection component has reduced the uncertainty. Further, the models at 108 need not be identical to the models at 102. For example, the models further defined at 200 may be numerical in nature, as opposed to geological models used at 102. Alternatively, the models at 108 are identical to the models at 102.

At 210, the methodology defines the set of candidate components for the data collection program. In particular, as the aim of the methodology is to reduce the subsurface uncertainty, one focus is to identify the data to be collected during the appraisal stage. As one example, the data collected may comprise the appraisal well location (e.g., by preferring a well at location A, in contrast to the well proposed at location B) and/or the data associated with the well. Examples may include, but are not limited to: the MDT data; well test data; etc. The set of data collection components may be denoted as dᵢ (i=1, 2, . . . , k), where k represents the total number data candidates at different proposed well locations. As another example, the data collected may comprise seismic data generated from receivers spaced a predetermined amount and with a certain frequency (or certain frequency range) wavelet.

At 220, the methodology quantifies the uncertainty reduction of QoI given the program different data collection components. In one or some embodiments, the methodology only seeks to collect data that may greatly reduce the uncertainty of QoI. To do so, the prior uncertainty of QoI, is first quantified, denoted as p(h). This may be performed through the numerical evaluation using the ensemble of models (M) which span the whole uncertainty space. p(h)=p(h(m), m=m₁, m₂, . . . , mₙ). Then, the posterior uncertainty of QoI given each dᵢ may be estimated. Different approaches may be implemented to perform this task. Merely by way of example, one method is to employ data driven methods as follows. First, a mapping between the QoI and any candidate data is built based on the training samples, denoting as gᵢ: dᵢ=g₁(h). Of note, the mapping is from the QoI to the data. Once the data is collected, one may apply one or more data driven workflows, which may provide efficient ways of estimating the posterior uncertainty pᵢ(h|dᵢ). For example, the methodology may apply a Bayesian inversion method (e.g., Bayesian Evidential Learning or BEL) to quantify the posterior uncertainty of QoI. See Caers J. (2018) Bayesianism in the Geosciences. In: Daya Sagar B Cheng Q., Agterberg F. (eds) Handbook of Mathematical Geosciences. Springer, Cham. https://doi.org/10.1007/978-3-319-78999-6_27, incorporated by reference herein in its entirety. Alternatively, the methodology may apply Goal Oriented Inference to estimate the posterior uncertainty pᵢ(h|dᵢ). See Hermans, T., Nguyen, F., Klepikova, M., Dassargues, A., Caers, J., “Uncertainty Quantification of Medium-Term Heat Storage From Short-Term Geophysical Experiments Using Bayesian Evidential Learning”, Water Resources Research, Volume 54, Issue 4 p. 2931-2948 (2018) https://doi.org/10.1002/2017WR022135, incorporated by reference herein in its entirety. Thus, in one or some embodiments, the main framework as illustrated in FIG. 1 comprises a Bayesian framework; however, there may be components of the flow diagram in FIG. 1 (e.g., approximation/estimation of the posterior distribution) that may be performed in multiple ways (e.g., Bayesian Evidential Learning, Goal-orient inference, etc.).

In this regard, in one embodiment, the sole metric for evaluating a respective data collection component comprises uncertainty reduction. Alternatively, multiple metrics, such as uncertainty reduction and cost associated with the respective data collection component, may be used to evaluate the respective data collection component (such as to rank the respective data collection component). In particular, separate from uncertainty reduction, the respective data collection component may have an associated costs, such as the cost to drill the appraisal well associated with the respective data collection component and/or the cost to perform the test associated with the respective data collection component. In this way, the respective data collection component may be ranked or evaluated based on the multiple criteria.

At 230, the methodology selects the top or highest ranked data component(s) that provide the largest uncertainty reduction. In particular, similar to step 3 (106), the methodology estimates the posterior uncertainty of QoI for all candidate data components pᵢ(h|dᵢ), i=1, 2, 3 . . . , k. Then, statistical metrics are defined to quantify the amount of uncertainty reduction based on the difference between the prior distribution and posterior distribution as follows:

distᵢ=∥p(h),p(h|dᵢ)∥ₚ

where ∥⋅∥ₚ is a norm and provides a distance metric. It is noted that the collection of data dᵢ is hypothesized and distᵢ provides a metric for effectiveness of gathering dᵢ on reduction of uncertainty of QoI. Then, the methodology may sort the data component candidates and select the data component that results in the greatest distᵢ (e.g., the metric for effectiveness of gathering dᵢ) for addition to the program. Example uncertainty determinations are disclosed in US Patent Application Publication No. 2018/0188403 A1 and US Patent Application Publication No. 2020/0124753 A1, both of which are incorporated by reference herein in their entirety.

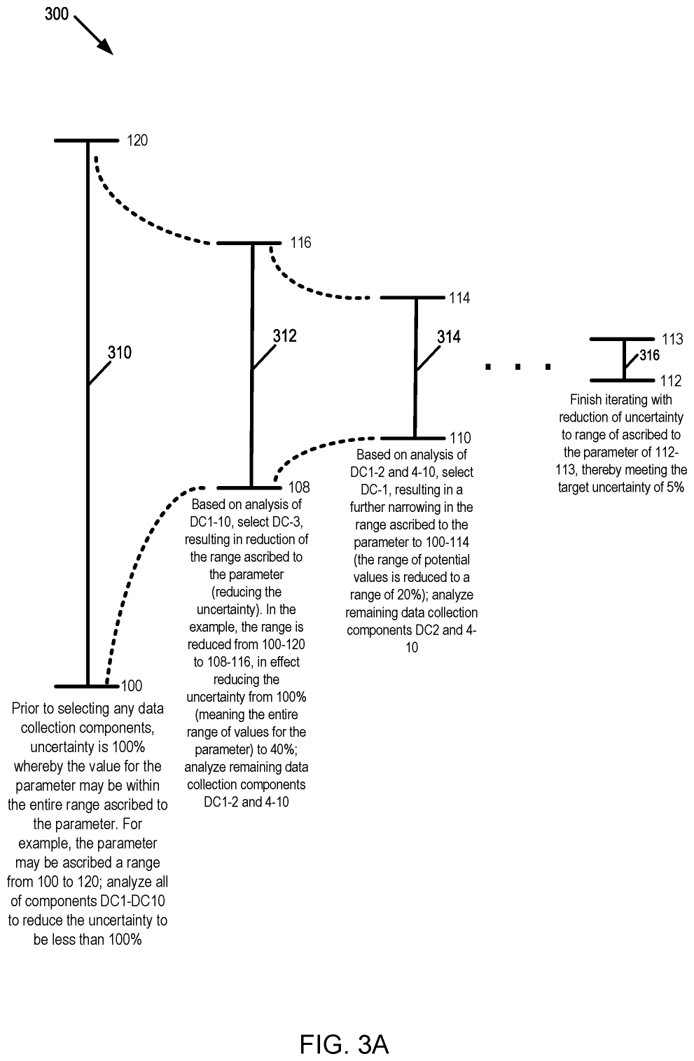

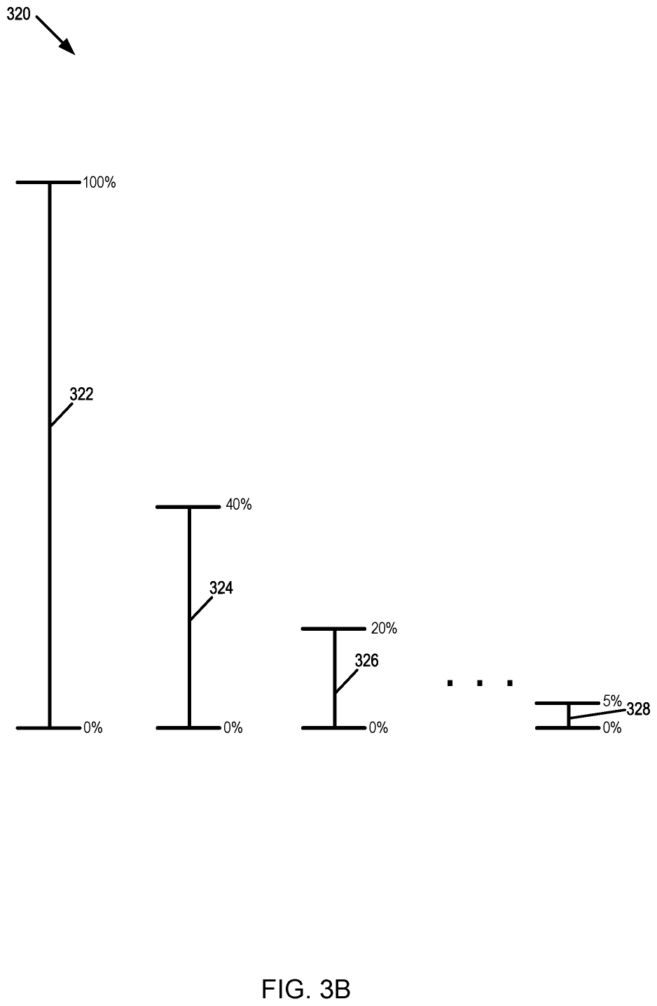

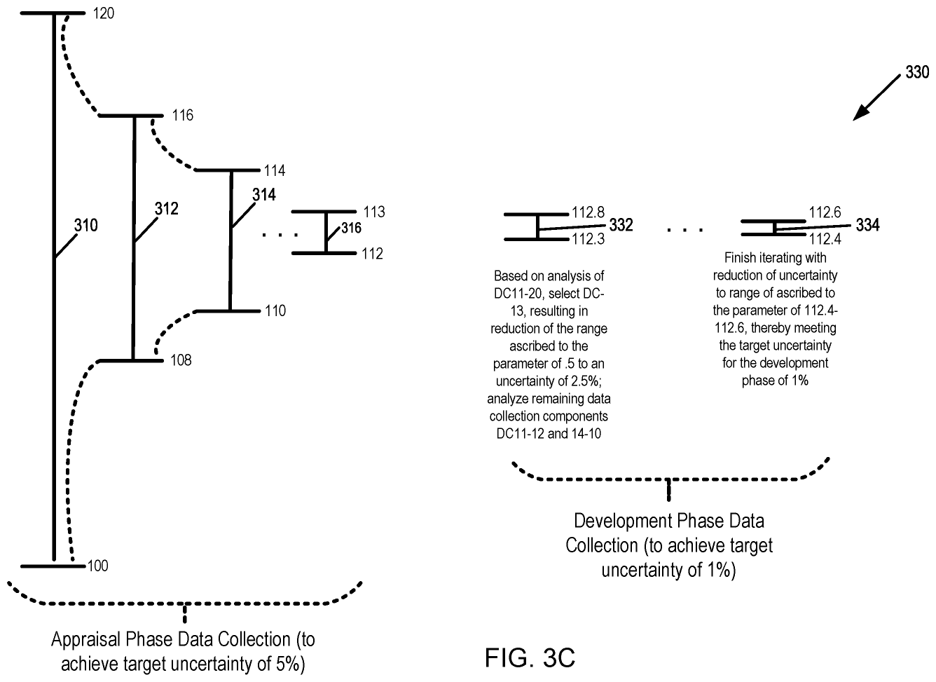

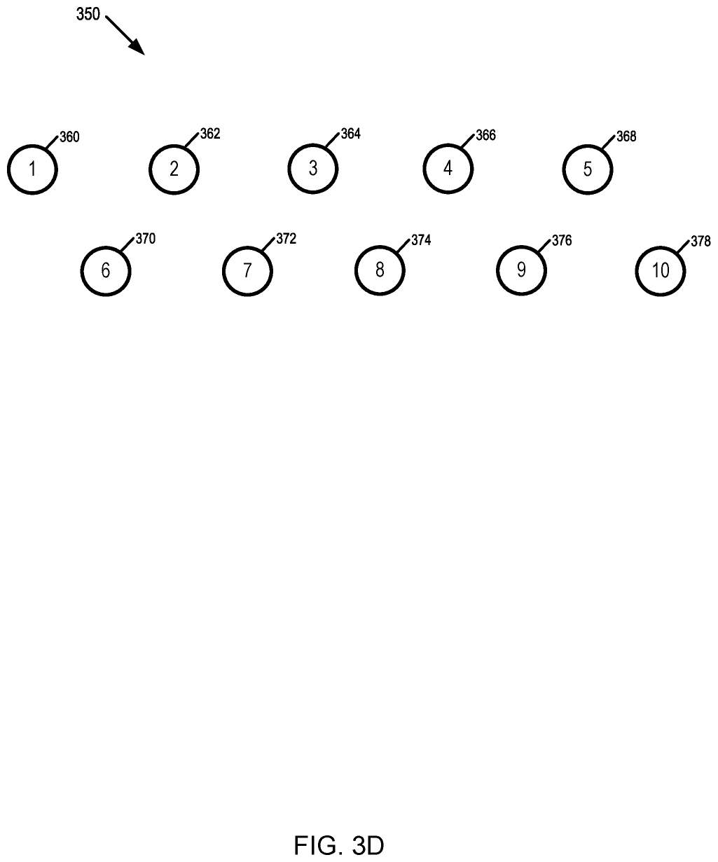

As discussed above, uncertainty reduction may be measured in one of several ways. In one way, uncertainty reduction may be measured based on a narrowing of the range of potential values for a respective QoI, as illustrated in FIG. 3A. Alternatively, or in addition, uncertainty reduction may be measured based on a percentage uncertainty, as illustrated in FIG. 3B.

FIG. 3A is a schematic 300 showing multiple iterations of selecting components to narrow a range of potential values for a respective QoI, thereby reducing uncertainty for a layout 350 of appraisal wells in FIG. 3D. Specifically, merely for purposes of a simple example, the set of potential data collection components may comprise 10 separate data collection components as DC1-DC10. Further, for purposes of example, each of the 10 separate data collection components, such that: DC1 is associated with appraisal well 1 (360), test 1, and duration 1; DC2 is associated with appraisal well 2 (362), test 2, and duration 2; DC3 is associated with appraisal well 3 (364), test 3, and duration 3; DC4 is associated with appraisal well 4 (366), test 4, and duration 4; DC5 is associated with appraisal well 5 (368), test 5, and duration 5; DC6 is associated with appraisal well 6 (370), test 6, and duration 6; DC7 is associated with appraisal well 7 (372), test 7, and duration 7; DC8 is associated with appraisal well 8 (374), test 8, and duration 8; DC9 is associated with appraisal well 9 (376), test 9, and duration 9; and DC10 is associated with appraisal well 10 (378), test 10, and duration 10. It is noted that, for the purposes of the example, the various tests 1-10 may be the same or different from one another, and the various durations may be the same or different from one another. It is further noted that data components for seismic designs may be used instead of (or in addition to) data collection components as DC1-DC10.

As shown in FIG. 3A, prior to selecting any data collection components, the entire range (310) of potential values for the respective QoI is from 100 to 120, so that the uncertainty is 100%. The methodology may then analyze each of DC1-DC10 in order to determine which data collection component results in the greatest reduction in the range of potential values. By way of example, the methodology may determine that the top ranked data collection components comprise: DC3; DC7; DC8. This comports with qualitative reasoning since each of DC3 (for appraisal well 3 (364)), DC7 (for appraisal well 7 (372)), and DC8 (for appraisal well 8 (374)) are generally in the middle of the field.

As such, in the first iteration and based on the analysis of DC1-DC10, the methodology selects DC3, resulting in the reduction of the range of potential values (312) to 108-116, thereby resulting in uncertainty 40%. In other words, after selecting DC3, the uncertainty is still 40% of the original range of potential values. After selecting DC3, the methodology may analyze some or all of the remaining data collection components (e.g., each of DC1-2 and 4-10) for additional uncertainty reduction assuming the data (and associated uncertainty reduction) obtained from DC3. By way of example, the methodology may determine that the top ranked data collection components comprise: DC1; DC4; DC5. This does not necessarily comport with qualitative reasoning since each of DC1 (for appraisal well 1 (360)), DC4 (for appraisal well 4 (366)), and DC5 (for appraisal well 5 (368)) are not generally in the middle of the field.

Thus, in the second iteration and based on the analysis of DC1-DC2 and DC4-DC10, the methodology selects DC1, resulting in the further reduction of range potential values (314) to 110-114, meaning that the uncertainty is 20%. After selecting DC3, the methodology may iterate one or more multiple times until the range of potential values (316) is 112-113, meaning that a remaining uncertainty of 5%, at which the uncertainty meets the target uncertainty criteria and iterations may cease.

FIG. 3B is another representation 320 of the effect of selecting data components with successive selections. In particular, prior to selecting data components, the uncertainty is 100% (322), meaning that there is no certainty as to the value of the respective QoI within the original potential range of values for the respective QoI. After selection of a first data component in a first iteration, the uncertainty is reduced to 40% (324), meaning that with the data obtained from the first data component, the range of values for the respective QoI is narrowed to 40% of the original potential range of values. After which, a second iteration leads to a selection of a second data component resulting in the uncertainty being 20% (326), meaning that with the data obtained from the second data component, the range of values for the respective QoI is narrowed to 20% of the original potential range of values. After further iteration(s) and selection of additional data component(s), the range of values for the respective QoI is narrowed to 5% (328) of the original potential range of values, at which the range meets the target uncertainty and iteration ends.

Further, the methodology may be performed in one or more phases for hydrocarbon resource management, such as in the appraisal phase and one or more other phases, as discussed above. In particular, the various phases may have a respective QoI or a respective set of QoIs for which uncertainty is to be reduced via data collection. In one or some embodiments, the respective QoI (or respective set of QoIs) may be the same for different phases of hydrocarbon resource management, as shown in the illustration 330 in FIG. 3C and discussed further below. Alternatively, the respective QoI (or respective set of QoIs) are different for different phases of hydrocarbon resource management.

Merely by way of example, a respective QoI may be subject to uncertainty reduction using the disclosed methodology in different stages, such as in an appraisal stage and in a development stage. Using the example illustrated in FIG. 3A, the methodology may be used in appraisal stage data collection (using the selected data components) in which the respective QoI is reduced to an uncertainty of 5%, which as discussed above is the target percentage uncertainty for the appraisal stage. Because data is still being collected, subsequent stages may further reduce the uncertainty for the respective QoI. For example, even during the development phase (which is not focused on data collection unlike the appraisal phase), data may still be sought in order to further narrow the uncertainty. See FIG. 3C. Thus, during the development phase, the methodology may further select data components in order to further reduce the uncertainty (such as to a 1% uncertainty). As shown, in analyzing the data components 11-20, the methodology selects data component 13, resulting in the range of values being further reduced to 112.3-112.8 (332), resulting in an uncertainty of 2.5%. After which, the methodology may iterate one or multiple times selecting additional data component(s) in order to finish iterating with a range of 112.4-112.6 (334), resulting in an uncertainty of 1% (which is the target uncertainty for the respective QoI for the development phase). In this way, the subsurface model, which may use the respective QoI (either as a parameter or as an output) may be further refined with the additional data generated by the selected components.

It is noted that the methodology may be performed at any time before or during a respective phase or respective phases. Merely by way of example, the production phase may span over many years. In this regard, data collection may be performed at the beginning of the production phase and/or during the production phase in order to further reduce uncertainty with regard to a process or action taken. For example, a water injection program, a gas injection program, in-field drilling or the like may be undertaken. Responsive to determining to perform these action(s), the methodology may be used to reduce uncertainty for one or more QoIs relevant to these actions in order to better design and perform these action.

In addition, the methodology may be sufficiently flexible in order to be applied to the different phases with different foci, including during the appraisal phase in which the extent of the asset is appraised, or in the development phase in which development wells are drilled to produce from a respective section of the field. Further, there may be instances where previous estimates may be incorrect. As such, further data collection using the disclosed methodology may be performed in order to confirm or refute the previous estimates.

In all practical applications, the present technological advancement must be used in conjunction with a computer, programmed in accordance with the disclosures herein. For example, FIG. 4 is a diagram of an exemplary computer system 400 that may be utilized to implement methods described herein. A central processing unit (CPU) 402 is coupled to system bus 404. The CPU 402 may be any general-purpose CPU, although other types of architectures of CPU 402 (or other components of exemplary computer system 400) may be used as long as CPU 402 (and other components of computer system 400) supports the operations as described herein. Those of ordinary skill in the art will appreciate that, while only a single CPU 402 is shown in FIG. 4, additional CPUs may be present. Moreover, the computer system 400 may comprise a networked, multi-processor computer system that may include a hybrid parallel CPU/GPU system. The CPU 402 may execute the various logical instructions according to various teachings disclosed herein. For example, the CPU 402 may execute machine-level instructions for performing processing according to the operational flow described.

The computer system 400 may also include computer components such as non-transitory, computer-readable media. Examples of computer-readable media include computer-readable non-transitory storage media, such as a random-access memory (RAM) 406, which may be SRAM, DRAM, SDRAM, or the like. The computer system 400 may also include additional non-transitory, computer-readable storage media such as a read-only memory (ROM) 408, which may be PROM, EPROM, EEPROM, or the like. RAM 406 and ROM 408 hold user and system data and programs, as is known in the art. The computer system 400 may also include an input/output (I/O) adapter 410, a graphics processing unit (GPU) 414, a communications adapter 422, a user interface adapter 424, a display driver 416, and a display adapter 418.

The I/O adapter 410 may connect additional non-transitory, computer-readable media such as storage device(s) 412, including, for example, a hard drive, a compact disc (CD) drive, a floppy disk drive, a tape drive, and the like to computer system 400. The storage device(s) may be used when RAM 406 is insufficient for the memory requirements associated with storing data for operations of the present techniques. The data storage of the computer system 400 may be used for storing information and/or other data used or generated as disclosed herein. For example, storage device(s) 412 may be used to store configuration information or additional plug-ins in accordance with the present techniques. Further, user interface adapter 424 couples user input devices, such as a keyboard 428, a pointing device 426 and/or output devices to the computer system 400. The display adapter 418 is driven by the CPU 402 to control the display on a display device 420 to, for example, present information to the user such as subsurface images generated according to methods described herein.

The architecture of computer system 400 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 400 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft, Amazon, etc.

The above-described techniques, and/or systems implementing such techniques, can further include hydrocarbon management based at least in part upon the above techniques, including using the device in one or more aspects of hydrocarbon management. For instance, methods according to various embodiments may include managing hydrocarbons based at least in part upon the device and data representations constructed according to the above-described methods. In particular, such methods may use the device to evaluate various welds in the context of drilling a well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

The following example embodiments of the invention are also disclosed.

Embodiment 1: A computer-implemented method for selecting and implementing a plurality of data collection components in order to collect data regarding at least a part of a subsurface, the method comprising:

accessing a plurality of potential data collection components, each of the potential data collection components having one or both of an associated well and an associated test or seismic survey parameter designs for collecting data, the data used to characterize one or more quantities of interest (QoIs) regarding the subsurface, the one or more QoIs comprising one or more parameters that define a subsurface model or one or more outputs of the subsurface model;

quantitatively analyzing each of the plurality of potential data collection components for an uncertainty reduction on the one or more QoIs;

selecting, based on the quantitative analysis and from the plurality of potential data collection components, a set of data collection components for testing; and

implementing the set of data collection components for testing in order to collect the data to characterize the at least a part of the subsurface.

Embodiment 2: The method of embodiment 1,

wherein quantitatively analyzing comprises interdependently analyzing the plurality of potential data collection components at least by the data for one potential data collection component is assumed to characterize the one or more QoIs when analyzing one or more other potential data collection components.

Embodiment 3: The method of embodiments 1 or 2,

wherein the interdependent analysis comprises iterative analysis;

wherein a first data collection component is selected in a first iteration based on a greatest uncertainty reduction on the one or more QoIs; and

wherein, in one or more subsequent iterations, data collected from the first data collection component is assumed to be acquired in order to evaluate one or more remaining data collection components for the greatest uncertainty reduction on the one or more QoIs.

Embodiment 4: The method of any of embodiments 1-3, wherein the iterations are performed until one or both of:

the at least one metric meets or exceeds a predetermined uncertainty percentage value or a predetermined range of values; or

an uncertainty percentage value for all of the one or more QoIs or a range of values for all of the one or more QoIs change less than a predetermined amount from a previous iteration to a current iteration.

Embodiment 5: The method of claim 4, wherein quantitatively analyzing is based on both the uncertainty reduction and cost associated with performing a respective data collection component.

Embodiment 6: The method of any of embodiments 1-5,

wherein the one or more QoIs comprise both of:
one or more geological parameters or fluid parameters defining the subsurface model; or
static or dynamic behaviors of the subsurface as the one or more outputs of the subsurface model;

wherein quantitatively analyzing each of the plurality of potential data collection components for effect on the one or more QoIs comprises:
determining, for each of the at least some of the plurality of potential data collection components, a corresponding uncertainty reduction for the one or more QoIs by performing a respective potential data collection component; and

wherein selecting the set of data collection components comprises:
selecting the respective potential data collection components for the plurality of potential data collection components based on the corresponding uncertainty reduction for the one or more geological parameters or fluid parameters and the static or dynamic behaviors of the subsurface.

Embodiment 7: The method of any of embodiments 1-6,

wherein the uncertainty reduction for a respective QoI comprises a percentage uncertainty reduction for the respective QoI.

Embodiment 8: The method of any of embodiments 1-7,

wherein the uncertainty reduction for a respective QoI comprises a narrowing of a range of values associated with a respective QoI.

Embodiment 4: The method of any of embodiments 1-8,

wherein the set of data collection components are for an appraisal phase of hydrocarbon resource management.

Embodiment 10: The method of any of embodiments 1-9,

wherein the plurality of potential data collection components comprises one or both of:
a plurality of locations to drill appraisal wells into the subsurface and a plurality of tests to perform in the appraisal wells; or
a plurality of seismic survey parameter designs; and

wherein the set of data collection components selected are indicative of one or both of the locations at which to drill the appraisal wells and the tests to perform at the appraisal wells during an appraisal phase of hydrocarbon resource management or the parameters of a seismic survey.

Embodiment 11: The method of any of embodiments 1-10,

wherein a first QoI and a second QoI are subject to uncertainty reduction;

wherein the first QoI has a first target uncertainty reduction and the second QoI has a second target uncertainty reduction, the first target uncertainty reduction being different from the second target uncertainty reduction; and

wherein the set of data collection components are selected so that the uncertainty reduction for the first QoI at least meets the first target uncertainty reduction and for the second QoI at least meets the second target uncertainty reduction.

Embodiment 12: The method of any of embodiments 1-11,

wherein the set of data collection components are selected by:

first selecting the data collection components that most reduce the uncertainty for the first QoI to at least the first target uncertainty reduction; and

thereafter selecting the data collection components that most reduce a remaining uncertainty for the second QoI to at least the second target uncertainty reduction.

Embodiment 13: The method of any of embodiments 1-12,

wherein the set of data collection components are selected by:

weighting the uncertainty reduction for both of the first QoI and the second QoI in order to determine which of the plurality of potential data collection components to select to reduce the uncertainty reduction for the first QoI toward the first target uncertainty reduction and the uncertainty reduction for the second QoI toward the second target uncertainty reduction.

Embodiment 14: The method of any of embodiments 1-13,

wherein selecting the set of data collection components for testing comprises:

selecting an appraisal phase set of data collection components for use during the appraisal phase of hydrocarbon resource management; and

selecting one or both of a development phase set of data collection components for use during a development phase of hydrocarbon resource management or a production phase set of data collection components for use during a production phase of hydrocarbon resource management.

Embodiment 15: The method of any of embodiments 1-14,

wherein the one or more QoIs characterize subsurface performance;

wherein selecting an appraisal phase set of data collection components for use during the appraisal phase of hydrocarbon resource management comprises selecting the appraisal phase set of data collection components that result in the uncertainty reduction for the one or more QoIs to at least meet an appraisal phase target uncertainty reduction;

wherein selecting the development phase set of data collection components for use during the development phase of hydrocarbon resource management comprises selecting the development phase set of data collection components that result in the uncertainty reduction for the one or more QoIs to at least meet a development phase target uncertainty reduction; and

wherein the development phase target uncertainty reduction is smaller or less than the appraisal phase target uncertainty reduction.

Embodiment 16: The method of any of embodiments 1-15,

wherein the one or more QoIs subject to the uncertainty reduction using the appraisal phase set of data collection components is the same as the one or more QoIs subject to the uncertainty reduction using the development phase set of data collection components.

Embodiment 17: The method of any of embodiments 1-16,

wherein the plurality of potential data collection components comprises a plurality of locations to drill appraisal wells into the subsurface and a plurality of tests to perform in the appraisal wells.

Embodiment 18: The method of any of embodiments 1-17,

wherein the plurality of potential data collection components comprises a plurality of seismic survey parameter designs.

Embodiment 19: The method of any of embodiments 1-18,

wherein the one or more QoIs comprises:
a first QoI comprising a subsurface parameter of the subsurface model;
a second QoI comprising an output that is based on the subsurface parameter and at least one input to the subsurface model; and

wherein the set of data collection components for testing reduces uncertainty for both the first QoI and the second QoI to respective target uncertainty reductions.

Embodiment 20: The method of any of embodiments 1-19,

wherein the plurality of potential data collection components comprises both of:
a plurality of locations to drill appraisal wells into the subsurface and a plurality of tests to perform in the appraisal wells; or
a plurality of seismic survey parameter designs; and

wherein the set of data collection components selected are indicative of both of the locations at which to drill the appraisal wells and the tests to perform at the appraisal wells during an appraisal phase of hydrocarbon resource management and the parameters of a seismic survey.

Embodiment 21: A system comprising:

a processor; and

a non-transitory machine-readable medium comprising instructions that, when executed by the processor, cause a computing system to perform a method according to any of embodiments 1-20.

Embodiment 22: A non-transitory machine-readable medium comprising instructions that, when executed by a processor, cause a computing system to perform a method according to any of embodiments 1-20.

What is claimed is:

1. A computer-implemented method for selecting and implementing a plurality of data collection components in order to collect data regarding at least a part of a subsurface, the method comprising:
accessing a plurality of potential data collection components, each of the potential data collection components having one or both of an associated well and an associated test or seismic survey parameter designs for collecting data, the data used to characterize one or more quantities of interest (QoIs) regarding the subsurface, the one or more QoIs comprising one or more parameters that define a subsurface model or one or more outputs of the subsurface model;
quantitatively analyzing each of the plurality of potential data collection components for an uncertainty reduction on the one or more QoIs;
selecting, based on the quantitative analysis and from the plurality of potential data collection components, a set of data collection components for testing; and
implementing the set of data collection components for testing in order to collect the data to characterize the at least a part of the subsurface.

2. The method of claim 1, wherein quantitatively analyzing comprises interdependently analyzing the plurality of potential data collection components at least by the data for one potential data collection component is assumed to characterize the one or more QoIs when analyzing one or more other potential data collection components.

3. The method of claim 2, wherein the interdependent analysis comprises iterative analysis;
wherein a first data collection component is selected in a first iteration based on a greatest uncertainty reduction on the one or more QoIs; and
wherein, in one or more subsequent iterations, data collected from the first data collection component is assumed to be acquired in order to evaluate one or more remaining data collection components for the greatest uncertainty reduction on the one or more QoIs.

4. The method of claim 3, wherein the iterations are performed until one or both of:
the at least one metric meets or exceeds a predetermined uncertainty percentage value or a predetermined range of values; or
an uncertainty percentage value for all of the one or more QoIs or a range of values for all of the one or more QoIs change less than a predetermined amount from a previous iteration to a current iteration.

5. The method of claim 4, wherein quantitatively analyzing is based on both the uncertainty reduction and cost associated with performing a respective data collection component.

6. The method of claim 1, wherein the one or more QoIs comprise both of:
one or more geological parameters or fluid parameters defining the subsurface model; or
static or dynamic behaviors of the subsurface as the one or more outputs of the subsurface model;
wherein quantitatively analyzing each of the plurality of potential data collection components for effect on the one or more QoIs comprises:
determining, for each of the at least some of the plurality of potential data collection components, a corresponding uncertainty reduction for the one or more QoIs by performing a respective potential data collection component; and
wherein selecting the set of data collection components comprises:
selecting the respective potential data collection components for the plurality of potential data collection components based on the corresponding uncertainty reduction for the one or more geological parameters or fluid parameters and the static or dynamic behaviors of the subsurface.

7. The method of claim 6, wherein the uncertainty reduction for a respective QoI comprises a percentage uncertainty reduction for the respective QoI.

8. The method of claim 6, wherein the uncertainty reduction for a respective QoI comprises a narrowing of a range of values associated with a respective QoI.

9. The method of claim 1, wherein the set of data collection components are for an appraisal phase of hydrocarbon resource management.

10. The method of claim 9, wherein the plurality of potential data collection components comprises one or both of:
a plurality of locations to drill appraisal wells into the subsurface and a plurality of tests to perform in the appraisal wells; or
a plurality of seismic survey parameter designs; and
wherein the set of data collection components selected are indicative of one or both of the locations at which to drill the appraisal wells and the tests to perform at the appraisal wells during an appraisal phase of hydrocarbon resource management or the parameters of a seismic survey.

11. The method of claim 10, wherein a first QoI and a second QoI are subject to uncertainty reduction;
wherein the first QoI has a first target uncertainty reduction and the second QoI has a second target uncertainty reduction, the first target uncertainty reduction being different from the second target uncertainty reduction; and
wherein the set of data collection components are selected so that the uncertainty reduction for the first QoI at least meets the first target uncertainty reduction and for the second QoI at least meets the second target uncertainty reduction.

12. The method of claim 11, wherein the set of data collection components are selected by:
first selecting the data collection components that most reduce the uncertainty for the first QoI to at least the first target uncertainty reduction; and
thereafter selecting the data collection components that most reduce a remaining uncertainty for the second QoI to at least the second target uncertainty reduction.

13. The method of claim 11, wherein the set of data collection components are selected by:
weighting the uncertainty reduction for both of the first QoI and the second QoI in order to determine which of the plurality of potential data collection components to select to reduce the uncertainty reduction for the first QoI toward the first target uncertainty reduction and the uncertainty reduction for the second QoI toward the second target uncertainty reduction.

14. The method of claim 10, wherein selecting the set of data collection components for testing comprises:
selecting an appraisal phase set of data collection components for use during the appraisal phase of hydrocarbon resource management; and
selecting one or both of a development phase set of data collection components for use during a development phase of hydrocarbon resource management or a production phase set of data collection components for use during a production phase of hydrocarbon resource management.

15. The method of claim 14, wherein the one or more QoIs characterize subsurface performance;
wherein selecting an appraisal phase set of data collection components for use during the appraisal phase of hydrocarbon resource management comprises selecting the appraisal phase set of data collection components that result in the uncertainty reduction for the one or more QoIs to at least meet an appraisal phase target uncertainty reduction;
wherein selecting the development phase set of data collection components for use during the development phase of hydrocarbon resource management comprises selecting the development phase set of data collection components that result in the uncertainty reduction for the one or more QoIs to at least meet a development phase target uncertainty reduction; and
wherein the development phase target uncertainty reduction is smaller or less than the appraisal phase target uncertainty reduction.

16. The method of claim 15, wherein the one or more QoIs subject to the uncertainty reduction using the appraisal phase set of data collection components is the same as the one or more QoIs subject to the uncertainty reduction using the development phase set of data collection components.

17. The method of claim 1, wherein the plurality of potential data collection components comprises a plurality of locations to drill appraisal wells into the subsurface and a plurality of tests to perform in the appraisal wells.

18. The method of claim 1, wherein the plurality of potential data collection components comprises a plurality of seismic survey parameter designs.

19. The method of claim 1, wherein the one or more QoIs comprises:
a first QoI comprising a subsurface parameter of the subsurface model;
a second QoI comprising an output that is based on the subsurface parameter and at least one input to the subsurface model; and
wherein the set of data collection components for testing reduces uncertainty for both the first QoI and the second QoI to respective target uncertainty reductions.

20. The method of claim 1, wherein the plurality of potential data collection components comprises both of:
a plurality of locations to drill appraisal wells into the subsurface and a plurality of tests to perform in the appraisal wells; or
a plurality of seismic survey parameter designs; and
wherein the set of data collection components selected are indicative of both of the locations at which to drill the appraisal wells and the tests to perform at the appraisal wells during an appraisal phase of hydrocarbon resource management and the parameters of a seismic survey.
